(19) United States
(12) Patent Application Publication
(10) Pub. No.: US 2023/0337183 A1
(43) Pub. Date: Oct. 19, 2023

(54) METHOD AND DEVICE USED FOR WIRELESS COMMUNICATION

(71) Applicants: Jinfang ZHANG, Shanghai (CN); Xiaobo ZHANG, Shanghai (CN)

(72) Inventors: Jinfang ZHANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/132,988

(22) Filed: Apr. 11, 2023

(30) Foreign Application Priority Data
Apr. 13, 2022 (CN) 202210388828.3

(51) Int. Cl. H04W 68/02; H04W 74/08; H04W 76/20

(52) U.S. Cl. CPC H04W 68/02; H04W 74/0833; H04W 76/20

(57) ABSTRACT

The present application provides a method and device used for wireless communications. A first node receives a first paging message; as a response to receiving the first paging message, monitors a first signaling in a first time window, the first signaling is used to indicate resuming a first radio bearer set; executes a first action at least according to whether the first signaling is received; herein, the behavior of executing a first action at least according to whether the first signaling is received comprises: when the first signaling is received and an uplink time is aligned, the first action is transmitting a first feedback message; when the first signaling is received and an uplink time is not aligned, or when the first signaling is not received, the first action is executing a first random access procedure. The present application effectively supports small data transmission.

### CROSS REFERENCE TO RELATED APPLICATIONS

This application claims the priority benefit of Chinese Patent Application No. 202210388828.3, filed on Apr. 13, 2022, the full disclosure of which is incorporated herein by reference.

### BACKGROUND

### Technical Field

The present application relates to methods and devices in wireless communication systems, and in particular to a method and device that support Downlink (DL)-triggered Small Data Transmission (SDT) in RRC_INACTIVE state in wireless communications.

### Related Art

Radio Resource Control Inactive state (RRC_INACTIVE state) is a newly introduced RRC state in New Radio (NR). When a user enters into the RRC_INACTIVE State, the user can reserve partial network configuration information. When a service arrives, the user can transfer data by re-entering into RRC_CONNECTED State. Until Rel (version)-16, data transmission in RRC_INACTIVE State is not supported in 3rd Generation Partner Project (3GPP) Radio Access Network (RAN).

Application scenarios of future wireless communication systems are becoming more and more diverse, with the rapid development of the Internet of Things (IoT), small data service will be an important service in future wireless communications. Small data services have characteristics of small data volume and low transmission frequency. For SDT, the signaling overhead of RRC state switching is greater than the transmission overhead of small data, which also increases the power consumption of User Equipment (UE). Therefore, at 3GPP RAN # 88e plenary, it was decided to initiate the standardization work of WI (Work Item) for SDT in RRC_INACTIVE State.

### SUMMARY

Inventors have found through researches that a UE is in RRC_INACTIVE state and when downlink data arrives, the network indicates the UE to access the network for data communication through paging the UE. Before accessing the network, the UE cannot determine whether downlink data to be received can be transmitted through small data, and therefore cannot determine whether to enter into RRC_CONNECTED state or to maintain data communications in RRC_INACTIVE state.

To address the above issues, the present application discloses a solution to support DL-triggered small data transmission in RRC_INACTIVE state, and the network can obtain the beneficial effects of saving the signaling overhead and power saving by transmitting a signaling to instruct the UE to maintain small data transmission in RRC_INACTIVE state. If no conflict is incurred, embodiments in a first node in the present application and the characteristics of the embodiments are also applicable to a second node, and vice versa. And the embodiments in the present application and the characteristics in the embodiments can be arbitrarily combined if there is no conflict. Though originally targeted at Uu air interface, the present application is also applicable to PC5 interface. Besides, the present application is not only targeted at scenarios of terminals and base stations, but also at to V2X scenarios, terminals and relays as well as communication scenarios between relays and base stations, where similar technical effect can be achieved. Additionally, the adoption of a unified solution for various scenarios, including but not limited to V2X scenarios and communication scenarios between terminals and base stations, contributes to the reduction of hardware complexity and costs. Particularly, for interpretations of the terminology, nouns, functions and variants (if not specified) in the present application, refer to definitions given in TS36 series, TS38 series and TS37 series of 3GPP specifications.

The present application provides a method in a first node for wireless communications, comprising:
receiving a first paging message, the first paging message indicating the first node;
as a response to receiving the first paging message, monitoring a first signaling in a first time window, the first signaling being used to indicate resuming all radio bearers in a first radio bearer set; and
executing a first action at least according to whether the first signaling is received;
herein, the first action is one of transmitting a first feedback message or executing a first random access procedure; the behavior of executing a first action at least according to whether the first signaling is received comprises: when the first signaling is received and an uplink time is aligned, the first action is transmitting a first feedback message; when the first signaling is received and an uplink time is not aligned, or when the first signaling is not received, the first action is executing a first random access procedure; the first feedback message is used to confirm a reception of the first signaling; any radio bearer in the first radio bearer set is used for a data transmission in RRC_INACTIVE State, and the first radio bearer set comprises at least one radio bearer.

In one embodiment, the above method is applicable for DL-triggered SDT.

In one embodiment, the above method indicates resuming all radio bearers in a first radio bearer set by monitoring a first signaling after receiving a first paging message, which can reduce the signaling overhead of DL-triggered SDT procedure and achieve beneficial effects of power saving.

In one embodiment, a length of the first time window is a value greater than 0.

In one embodiment, the length of the first time window is 0.

In one embodiment, the above method can flexibly achieve backward compatibility by monitoring a first signaling in a first time window.

In one embodiment, the above method executes a first action at least according to whether the first signaling is received, which can unify the solution and help reduce hardware complexity and cost.

In one embodiment, any radio bearer in the first radio bearer set is configured for data transmission in at least RRC_INACTIVE state.

In one embodiment, any radio bearer in the first radio bearer set is configured for DL-triggered SDT.

In one embodiment, any radio bearer in the first radio bearer set is configured for data transmission in RRC _CONNECTED state.

According to one aspect of the present application, comprising:

accompanying transmitting the first feedback message, resuming all radio bearers in the first radio bearer set.

In one embodiment, transmitting the first feedback message can avoid UE and network information from being out of sync, resulting in an incorrect reception by the UE.

According to one aspect of the present application, comprising:
when the first signaling is received and an uplink time is not aligned, accompanying executing a first random access procedure, resuming all radio bearers in the first radio bearer set;
herein, the first random access procedure is an SDT-triggered random access procedure.

In one embodiment, through an SDT-triggered random access procedure, a DL-triggered SDT can be rapidly achieved; the SDT-triggered random access procedure is used for an Uplink (UL)-triggered SDT.

In one embodiment, a Radio Link Control (RLC) entity corresponding to all radio bearers in the first radio bearer set is configured as Acknowledged Mode (AM) or um-Bi-Directional.

According to one aspect of the present application, comprising:
when the first signaling is not received, and before the first random access procedure is successfully completed, all radio bearers in the first radio bearer set not being resumed;
herein, the first random access procedure is a non-SDT-triggered random access procedure.

In one embodiment, backward compatible network access can be achieved through non-SDT-triggered random access procedure.

In one embodiment, the non-SDT-triggered random access procedure comprises a random access procedure triggered from an RRC _CONNECTED recovery procedure in RRC_INACTIVE state.

In one embodiment, the non-SDT-triggered random access procedure comprises a random access procedure triggered from an initial access in RRC_IDLE state.

In one embodiment, the non-SDT-triggered random access procedure comprises a random access procedure triggered by requesting other System Information (SI).

According to one aspect of the present application, comprising:

at least a running state of a first timer being used to determine whether an uplink time is aligned.

According to one aspect of the present application, comprising:
receiving a first message before receiving the first paging message, the first message indicating the first radio bearer set; and
as a response to receiving the first message, maintaining or entering into the RRC_INACTIVE state;
herein, the first message indicates that the first timer is not considered expired.

In one embodiment, maintaining the first timer while maintaining or entering into the RRC_INACTIVE state can quickly judge whether the first feedback can be transmitted, so as to achieve the rapid interaction with the network.

According to one aspect of the present application, comprising:
the first signaling being used to activate a first scheduling;
herein, the first message indicates the first scheduling, and the first scheduling is executed after being activated and before being de-activated.

In one embodiment, the first signaling indicates that the first scheduling is activated.

In one embodiment, the first scheduling is Semi-Persistent Scheduling (SPS).

In one embodiment, implicitly indicating a DL-triggered SDT through the first scheduling activation command can effectively save the signaling overhead.

According to one aspect of the present application, comprising:

after all radio bearers in the first radio bearer set being resumed, receiving a first MAC PDU in the RRC_INACTIVE state, the first MAC PDU comprising at least one MAC subPDU, and a MAC subheader corresponding to each MAC SDU comprised in the at least one MAC subPDU indicating that the MAC SDU belongs to a radio bearer in the first radio bearer set.

In one embodiment, a Medium Access Control (MAC) subPDU only comprises one MAC subheader.

In one embodiment, a MAC subPDU comprises a MAC subheader and a MAC Control Element (CE).

In one embodiment, a MAC subPDU comprises a MAC subheader and a MAC Service Data Unit (SDU).

In one embodiment, a MAC subPDU comprises a MAC subheader and padding.

In one embodiment, a MAC subheader comprises at least one byte.

The present application provides a method in a second node for wireless communications, comprising:
transmitting a first paging message, the first paging message indicating the first node;
immediately after transmitting the first paging message, transmitting a first signaling in a first time window, the first signaling being used to indicate resuming all radio bearers in a first radio bearer set;
herein, a first action is executed at least according to whether the first signaling is received; the first action is one of transmitting a first feedback message or executing a first random access procedure; a first action being executed at least according to whether the first signaling is received comprises: when the first signaling is received and an uplink time is aligned, a first feedback message is transmitted; when the first signal is received and an uplink time is not aligned, or when the first signaling is not received, a first random access procedure is executed; the first feedback message is used to confirm a reception of the first signaling; any radio bearer in the first radio bearer set is used for a data transmission in RRC_INACTIVE State, and the first radio bearer set comprises at least one radio bearer.

According to one aspect of the present application, comprising:
receiving the first feedback message;
herein, the first signaling is received and an uplink time is aligned.

According to one aspect of the present application, comprising:
receiving a first random access preamble;
herein, the first signaling is received and an uplink time is not aligned; the behavior of receiving the first random access preamble belongs to the first random access procedure, and the first random access procedure is an SDT-triggered random access procedure.

According to one aspect of the present application, comprising:
receiving a first random access preamble;
herein, the first signaling is not received; the behavior of receiving the first random access preamble belongs to the first random access procedure, and the first random access procedure is a non-SDT-triggered random access procedure.

According to one aspect of the present application, comprising:

at least a running state of a first timer being used to determine whether an uplink time is aligned.

In one embodiment, the first timer is maintained by a receiver of the first signaling.

According to one aspect of the present application, comprising:

transmitting a first message before transmitting the first paging message, the first message indicating the first radio bearer set; herein, the first message is used to indicate maintaining or entering into the RRC_INACTIVE state, and the first message indicates that the first timer is not considered expired.

According to one aspect of the present application, comprising:
the first signaling being used to activate a first scheduling;
herein, the first message indicates the first scheduling, and the first scheduling is executed after being activated and before being de-activated.

According to one aspect of the present application, comprising:

after all radio bearers in the first radio bearer set being resumed, transmitting a first MAC PDU, the first MAC PDU comprising at least one MAC subPDU, and a MAC subheader corresponding to each MAC SDU comprised in the at least one MAC subPDU indicating that the MAC SDU belongs to a radio bearer in the first radio bearer set.

The present application provides a first node for wireless communications, comprising:
a first receiver, receiving a first paging message, the first paging message indicating the first node; as a response to receiving the first paging message, monitoring a first signaling in a first time window, the first signaling being used to indicate resuming all radio bearers in a first radio bearer set;
a first processor, executing a first action at least according to whether the first signaling is received;
herein, the first action is one of transmitting a first feedback message or executing a first random access procedure; the behavior of executing a first action at least according to whether the first signaling is received comprises: when the first signaling is received and an uplink time is aligned, the first action is transmitting a first feedback message; when the first signaling is received and an uplink time is not aligned, or when the first signaling is not received, the first action is executing a first random access procedure; the first feedback message is used to confirm a reception of the first signaling; any radio bearer in the first radio bearer set is used for a data transmission in RRC_INACTIVE State, and the first radio bearer set comprises at least one radio bearer.

The present application provides a second node for wireless communications, comprising:
a first transmitter, transmitting a first paging message, the first paging message indicating the first node; immediately after transmitting the first paging message, transmitting a first signaling in a first time window, the first signaling being used to indicate resuming all radio bearers in a first radio bearer set;
herein, a first action is executed at least according to whether the first signaling is received; the first action is one of transmitting a first feedback message or executing a first random access procedure; a first action being executed at least according to whether the first signaling is received comprises: when the first signaling is received and an uplink time is aligned, a first feedback message is transmitted; when the first signal is received and an uplink time is not aligned, or when the first signaling is not received, a first random access procedure is executed; the first feedback message is used to confirm a reception of the first signaling; any radio bearer in the first radio bearer set is used for a data transmission in RRC_INACTIVE State, and the first radio bearer set comprises at least one radio bearer.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of the processing of a signal in a first node according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of hardware modules of communication devices according to one embodiment of the present application;

FIG. 5 illustrates a flowchart of radio signal transmission when a first signaling is received and uplink time is aligned according to one embodiment of the present application;

FIG. 6 illustrates a flowchart of radio signal transmission when a first signaling is received and uplink time is not aligned according to one embodiment of the present application;

FIG. 7 illustrates a flowchart of radio signal transmission when a first signaling is not received according to an embodiment of the present application;

FIG. 8 illustrates a schematic diagram of a first time window according to one embodiment of the present application;

FIG. 9 illustrates a flowchart of the specific signal processing in a first node according to one embodiment of the present application;

FIG. 10 illustrates a structure block diagram of a processor in a first node according to one embodiment of the present application;

FIG. 11 illustrates a structure block diagram of a processor in second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

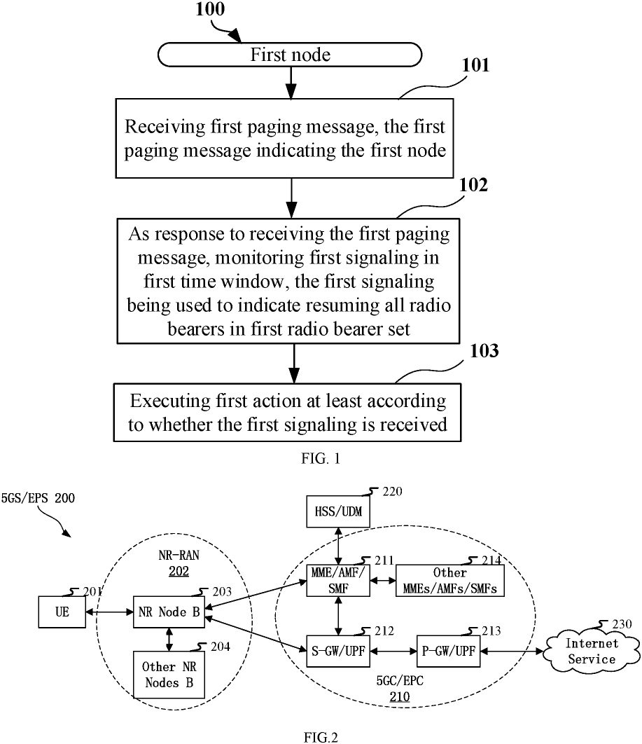

Embodiment 1 illustrates a flowchart of the processing of a signal in a first node according to one embodiment of the present application, as shown in FIG. 1.

In embodiment 1, a first node 100 receives a first paging message in step 101, and the first paging message indicates the first node; as a response to receiving the first paging message in step 102, monitors a first signaling in a first time window, the first signaling is used to indicate resuming all radio bearers in a first radio bearer set; executes a first action at least according to whether the first signaling is received in step 103; herein, the first action is one of transmitting a first feedback message or executing a first random access procedure; the behavior of executing a first action at least according to whether the first signaling is received comprises: when the first signaling is received and an uplink time is aligned, the first action is transmitting a first feedback message; when the first signaling is received and an uplink time is not aligned, or when the first signaling is not received, the first action is executing a first random access procedure; the first feedback message is used to confirm a reception of the first signaling; any radio bearer in the first radio bearer set is used for a data transmission in RRC_INACTIVE State, and the first radio bearer set comprises at least one radio bearer.

In one embodiment, when the first paging message is received, the first node is in RRC_INACTIVE state.

In one embodiment, a first paging message is received, and the first paging message indicates the first node.

In one embodiment, the first paging message is received in a paging occasion of the first node.

In one embodiment, the first paging message is an RAN paging message.

In one embodiment, the first paging message is not a core network (CN) paging message.

In one embodiment, the first paging message is not used to change an RRC state where the first node is located.

In one embodiment, the first paging message comprises a first identity.

In one embodiment, the first identity is used to identify the first node in RRC_INACTIVE state.

In one embodiment, the first identity is allocated by RAN.

In one embodiment, the first identity is not allocated by upper layer.

In one embodiment, the upper layer is core network.

In one embodiment, the upper layer is Non-access stratum (NAS).

In one embodiment, the first identity is an Inactive-Radio Network Temporary Identifier (I-RNTI).

In one embodiment, the first identity comprises a complete I-RNTI value.

In one embodiment, the first identity comprises 40 bits.

In one embodiment, as a response to receiving the first paging message, a first signaling is monitored in a first time window.

In one embodiment, a first signaling is monitored via an air interface.

In one embodiment, the air interface comprises an interface of radio signal transmission.

In one embodiment, the air interface comprises Uu.

In one embodiment, the meaning of the monitoring comprises searching.

In one embodiment, the meaning of monitoring comprises monitoring.

In one embodiment, the phrase of monitoring the first signaling comprises: determining whether there exists the first signaling through energy monitoring.

In one embodiment, the phrase of monitoring the first signaling comprises: determining whether there exists the first signaling through a coherent detection.

In one embodiment, the phrase of monitoring the first signaling comprises: determining whether there exists the first signaling through a bandwidth detection.

In one embodiment, the phrase of monitoring the first signaling comprises: determining whether there exists the first signaling through a related detection.

In one embodiment, the phrase of monitoring the first signaling comprises: determining whether there exists the first signaling through a synchronization detection.

In one embodiment, the phrase of monitoring the first signaling comprises: determining whether there exists the first signaling through a waveform detection.

In one embodiment, the phrase of monitoring the first signaling comprises: determining whether there exists the first signaling through a maximum likelihood detection.

In one embodiment, the phrase of monitoring the first signaling comprises: determining whether there exists the first signaling through a blind decoding detection.

In one embodiment, the phrase of monitoring the first signaling comprises: monitoring the first signaling on Physical Downlink Control CHannel (PDCCH) resources.

In one embodiment, decoding is executed on the first signaling, and whether the decoding is correct is judged according to Cyclic Redundancy Check (CRC); if CRC is not passed, the first signaling is not monitored; if CRC is passed, the first signaling is successfully monitored.

In one embodiment, the first signaling is used to resume all radio bearers in the first radio bearer set.

In one embodiment, the first signaling is used to indicate resuming Signaling Radio Bearer 1 (SRB1).

In one embodiment, the first signaling is used to indicate executing an SDT procedure.

In one embodiment, the first signaling is used to indicate executing a DL-triggered SDT procedure.

In one embodiment, a name of the first signaling comprises SDT.

In one embodiment, a name of the first signaling comprises a DL-SDT.

In one embodiment, a name of the first signaling comprises a mobile-terminated (MT)-SDT.

In one embodiment, a name of the first signaling comprises an SDT Activation.

In one embodiment, the first signaling is a MAC sublayer signaling.

In one embodiment, the first signaling is a MAC CE.

In one embodiment, the first signaling is a MAC CE with 0-bit fixed size.

In one embodiment, the first signaling comprises at least one byte.

In one embodiment, the first signaling is a MAC CE, and a first logical channel identity is used to indicate the MAC CE.

In one embodiment, a value of the first logical channel identity is a positive integer between 35 and 46, comprising 35 and 46.

In one embodiment, a value of the first logical channel identity is a positive integer between 64 and 308, comprising 64 and 308.

In one embodiment, the first signaling is a physical-layer signaling.

In one embodiment, the first signaling does not comprise a higher-layer signaling.

In one embodiment, the higher-layer signaling is an RRC signaling.

In one embodiment, the higher-layer signaling is a NAS signaling.

In one embodiment, the first signaling is not used to switch an RRC state where the first node is located.

In one embodiment, the first signaling is scrambled by a Cell-RNTI (C-RNTI).

In one embodiment, the first radio bearer set comprises a signaling radio bearer other than SRB1.

In one embodiment, the first radio bearer set comprises an SRB2.

In one embodiment, the first radio bearer set comprises an SRB3.

In one embodiment, the first radio bearer set comprises a data radio bearer (DRB).

In one embodiment, the first radio bearer set comprises a multicast/broadcast service (MBS) MRB.

In one embodiment, any radio bearer comprised in the first radio bearer set maintains a suspended state before receiving the first signaling.

In one embodiment, any radio bearer in the first radio bearer set is used for a data transmission in RRC_INACTIVE State, and the first radio bearer set comprises at least one radio bearer.

In one embodiment, any radio bearer comprised in the first radio bearer set is configured for an SDT transmission.

In one embodiment, any radio bearer comprised in the first radio bearer set is configured for a DL-triggered SDT transmission.

In one embodiment, any radio bearer comprised in the first radio bearer set is configured for data transmission in RRC_INACTIVE state and data transmission in RRC_CONNECTED state.

In one embodiment, any radio bearer in the first radio set is one of DRB or SRB2.

In one embodiment, any radio bearer in the first radio set is one of DRB, or MRB or SRB2.

In one embodiment, a first action is executed based on whether the first signaling is received; herein, the first action is one of transmitting a first feedback message or executing a first random access procedure.

In one embodiment, the first feedback message is used to confirm a reception of the first signaling.

In one embodiment, the first feedback message is a confirmation message.

In one embodiment, the first feedback message is a physical-layer message.

In one embodiment, the first feedback message is a UE-specific sequence.

In one embodiment, the first feedback message is ACKnowledgement (ACK).

In one embodiment, the first feedback message occupies a third time-frequency resource.

In one subembodiment of the above embodiment, the third time-frequency resource is UE-specific.

In one subembodiment of the above embodiment, the third time-frequency resource is network-configured.

In one subembodiment of the above embodiment, the third time-frequency resource is configured by a Physical Uplink Control Channel (PUCCH)-config.

In one subembodiment of the above embodiment, the third time-frequency resource is configured on a default BandWidth Part (BWP) of the first node.

In one subembodiment of the above embodiment, the third time-frequency resource is configured on an initial BWP of the first node.

In one subembodiment of the above embodiment, the third time-frequency resource and an SPS resource configured by the first node are on a same BWP.

In one subembodiment of the above embodiment, the third time-frequency resource and time-frequency resources indicated by the first scheduling are on a same BWP.

In one embodiment, when the first signaling is received and an uplink time is aligned, the first action is transmitting a first feedback message.

In one embodiment, when the first signaling is received and an uplink time is not aligned, the first action is executing a first random access procedure.

In one embodiment, when the first signaling is not received, the first action is executing a first random access procedure.

### Embodiment 2

Embodiment 2 illustrates a schematic diagram of a network architecture according to one embodiment of the present application, as shown in FIG. 2. FIG. 2 is a diagram illustrating a network architecture 200 of 5G NR, Long-Term Evolution (LTE), and Long-Term Evolution Advanced (LTE-A) systems. The NR 5G, LTE or LTE-A network architecture 200 may be called a 5G System (5GS)/Evolved Packet System (EPS) 200 or other appropriate terms. The 5GS/ EPS 200 may comprise one or more UEs 201, an NG-RAN 202, a 5G-Core Network/Evolved Packet Core (5GC/ EPC) 210, a Home Subscriber Server (HSS)/ Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms, and in Non Terrestrial Networks (NTNs), the gNB 203 can be a satellite, an aircraft or a terrestrial base station relayed through a satellite. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, vehicle equipment, On-board communication unit, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/ Session Management Function (SMF) 211, other MMEs/ AMFs/ SMFs 214, a Service Gateway (S-GW)/ User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to the first node in the present application.

In one embodiment, the NR node B 203 corresponds to a second node in the present application.

In one embodiment, the gNB 203 is a Marco Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station that supports large delay differences.

In one embodiment, the gNB 203 is a flight platform.

In one embodiment, the gNB 203 is satellite equipment.

In one embodiment, the gNB 203 is a test device (e.g., a transceiver device simulating partial functions of a base station, a signaling tester).

In one embodiment, a radio link from the UE 201 to the gNB 203 is an uplink, and the uplink is used for executing an uplink transmission.

In one embodiment, a radio link from the gNB 203 to the UE 201 is a downlink, and the downlink is used for executing a downlink transmission.

In one embodiment, the UE 201 and the gNB 203 are connected via a Uu interface.

### Embodiment 3

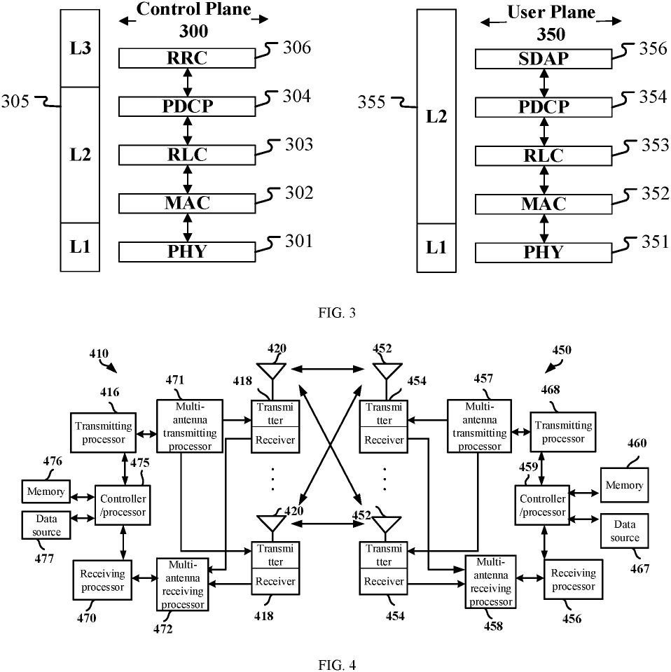

Embodiment 3 illustrates a schematic diagram of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for the control plane 300 of a UE and a gNB is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of the link between the UE and the gNB via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the gNBs of the network side. The PDCP sublayer 304 provides data encryption and integrity protection and also provides support for a UE handover between gNBs. The RLC sublayer 303 provides segmentation and reassembling of a packet, retransmission of a lost data packet through ARQ, as well as repeat data packet detection and protocol error detection. The MAC sublayer 302 provides mapping between a logic channel and a transport channel and multiplexing of the logical channel ID. The MAC sublayer 302 is also responsible for allocating between UEs various radio resources (i.e., resources block) in a cell. The MAC sublayer 302 is also responsible for Hybrid Automatic Repeat Request (HARQ) operation. The Radio Resource Control (RRC) sublayer 306 in layer 3 (L3) of the control plane 300 is responsible for acquiring radio resources (i.e., radio bearer) and configuring the lower layer with an RRC signaling between the gNB and the UE. Although not shown, the RRC sublayer 306 in the control plane 300 of the UE may also have a V2X layer, and the V2X layer is responsible for generating a PC5 QoS parameter group and QoS rules according to received service data or service requests, a PC5 QoS flow is generated corresponding to a PC5 QoS parameter group, and a PC5 QoS flow ID and the corresponding PC5 QoS parameter group are transmitted to an Access Stratum (AS) Layer for QoS processing of a packet belonging to the PC5 QoS flow ID by the AS layer; the V2X layer also comprises a PC5-Signaling Protocol sublayer, and the V2X layer is responsible for indicating whether each transmission of the AS layer is a PC5-S transmission or a V2X service data transmission. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. The radio protocol architecture of the UE in the user plane 350 may comprises part or all of protocol sublayers of the SDAP sublayer 356, the PDCP sublayer 354, the RLC sublayer 353 and the MAC subalyer 352 at L2 layer. Although not described in FIG. 3, the UE may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, entities of multiple sublayers of the control plane in FIG. 3 form a Signaling Radio Bear (SRB) in the vertical direction.

In one embodiment, entities of multiple sublayers of the user plane in FIG. 3 form a Data Radio Bear (DRB) in the vertical direction.

In one embodiment, entities of multiple sublayers of the user plane in FIG. 3 form an MBS Radio Bearer (MRB) in the vertical direction.

In one embodiment, the radio protocol architecture in FIG. 3 is applicable to the first node in the present application.

In one embodiment, the radio protocol architecture in FIG. 3 is applicable to the second node in the present application.

In one embodiment, the first paging message in the present application is generated by the RRC 306.

In one embodiment, the first signaling in the present application is generated by the MAC 302 or the MAC 352.

In one embodiment, the first signaling in the present application is generated by the PHY 301 or the PHY 351.

In one embodiment, the first feedback message in the present application is generated by the PHY 301 or the PHY 351.

In one embodiment, the first message in the present application is generated by the RRC 306.

In one embodiment, the first random access preamble in the present application is generated by the PHY 301 or the PHY 351.

In one embodiment, the first MAC PDU in the present application is generated by the MAC 302 or the MAC 352.

In one embodiment, the RRC resume request message in the present application is generated by the RRC 306.

In one embodiment, the L2 layer 305 or 355 belongs to a higher layer.

In one embodiment, the L3 layer RRC sublayer 306 belongs to a higher layer.

### Embodiment 4

Embodiment 4 illustrates a schematic diagram of hardware modules of a communication device according to one embodiment of the present application, as shown in FIG. 4. FIG. 4 is a block diagram of a first communication device 450 in communication with a second communication device 410 in an access network.

The first communication device 450 comprises a controller/ processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/ processor 475, a memory 476, a data source 477, a receiving processor 470, a transmitting processor 416, a multi-antenna receiving processor 472, a multi-antenna transmitting processor 471, a transmitter/ receiver 418 and an antenna 420.

In a transmission from the second communication device 410 to the first communication device 450, at the second communication device 410, a higher layer packet from the core network or a higher layer packet from the data source 477 is provided to the controller/ processor 475. The core network and the data source 477 represents all protocol layers above the L2 layer. The controller/processor 475 provides a function of the L2 layer. In the transmission from the second communication device 410 to the first communication device 450, the controller/ processor 475 provides header compression, encryption, packet segmentation and reordering, and multiplexing between a logical channel and a transport channel, and radio resources allocation for the first communication device 450 based on various priorities. The controller/ processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 resumes information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/ beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In a transmission from the second communication device 410 to the first communication device 450, the controller/processor 459 provides multiplexing between a transport channel and a logical channel, packet reassembling, decryption, header decompression, control signal processing so as to recover a higher-layer packet from the second communication device 410. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the first communication device 450. The higher layer packet from the controller / processor 475 can be provided to all protocol layers above the core network or the L2 layer, and various control signals can also be provided to the core network or L3 layer for L3 layer processing.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: receives a first paging message, the first paging message indicates the first node; as a response to receiving the first paging message, monitors a first signaling in a first time window, the first signaling is used to indicate resuming all radio bearers in a first radio bearer set; at least executes a first action based on whether the first signaling is received; herein, the first action is one of transmitting a first feedback message or executing a first random access procedure; the behavior of executing a first action at least according to whether the first signaling is received comprises: when the first signaling is received and an uplink time is aligned, the first action is transmitting a first feedback message; when the first signaling is received and an uplink time is not aligned, or when the first signaling is not received, the first action is executing a first random access procedure; the first feedback message is used to confirm a reception of the first signaling; any radio bearer in the first radio bearer set is used for a data transmission in RRC_INACTIVE State, and the first radio bearer set comprises at least one radio bearer.

In one embodiment, the first communication device 450 comprises: a memory that stores a computer readable instruction program. The computer readable instruction program generates an action when executed by at least one processor. The action includes: receiving a first paging message, the first paging message indicating the first node; as a response to receiving the first paging message, monitoring a first signaling in a first time window, the first signaling being used to indicate resuming all radio bearers in a first radio bearer set; executing a first action at least according to whether the first signaling is received; herein, the first action is one of transmitting a first feedback message or executing a first random access procedure; the behavior of executing a first action at least according to whether the first signaling is received comprises: when the first signaling is received and an uplink time is aligned, the first action is transmitting a first feedback message; when the first signaling is received and an uplink time is not aligned, or when the first signaling is not received, the first action is executing a first random access procedure; the first feedback message is used to confirm a reception of the first signaling; any radio bearer in the first radio bearer set is used for a data transmission in RRC_INACTIVE State, and the first radio bearer set comprises at least one radio bearer.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first paging message, the first paging message indicates the first node; immediately after transmitting the first paging message, transmits a first signaling in a first time window, the first signaling is used to indicate resuming all radio bearers in a first radio bearer set; herein, a first action is executed at least according to whether the first signaling is received; the first action is one of transmitting a first feedback message or executing a first random access procedure; a first action being executed at least according to whether the first signaling is received comprises: when the first signaling is received and an uplink time is aligned, a first feedback message is transmitted; when the first signal is received and an uplink time is not aligned, or when the first signaling is not received, a first random access procedure is executed; the first feedback message is used to confirm a reception of the first signaling; any radio bearer in the first radio bearer set is used for a data transmission in RRC_INACTIVE State, and the first radio bearer set comprises at least one radio bearer.

In one embodiment, the second communication device 410 comprises a memory that stores a computer readable instruction program. The computer readable instruction program generates an action when executed by at least one processor. The action includes: transmitting a first paging message, the first paging message indicating the first node; immediately after transmitting the first paging message, transmitting a first signaling in a first time window, the first signaling being used to indicate resuming all radio bearers in a first radio bearer set; herein, a first action is executed at least according to whether the first signaling is received; the first action is one of transmitting a first feedback message or executing a first random access procedure; a first action being executed at least according to whether the first signaling is received comprises: when the first signaling is received and an uplink time is aligned, a first feedback message is transmitted; when the first signal is received and an uplink time is not aligned, or when the first signaling is not received, a first random access procedure is executed; the first feedback message is used to confirm a reception of the first signaling; any radio bearer in the first radio bearer set is used for a data transmission in RRC_INACTIVE State, and the first radio bearer set comprises at least one radio bearer.

In one embodiment, the first communication device 450 corresponds to a first node in the present application.

In one embodiment, the second communication device 410 corresponds to a second node in the present application.

In one embodiment, the first communication device 450 is a UE.

In one embodiment, the second communication device 410 is a base station.

In one embodiment, at least one of the antenna 420, the transmitter 418, the multi-antenna transmitting processor 471, the transmitting processor 416 or the controller/processor 475 is used to transmit a first paging message in the present application.

In one embodiment, at least one of the antenna 452, the receiver 454, the multi-antenna receiving processor 458, the receiving processor 456 or the controller/processor 459 is used to receive a first paging message in the present application.

In one embodiment, at least one of the antenna 420, the transmitter 418, the multi-antenna transmitting processor 471, the transmitting processor 416 or the controller/processor 475 is used to transmit a first signaling in the present application.

In one embodiment, at least one of the antenna 452, the receiver 454, the multi-antenna receiving processor 458, the receiving processor 456 or the controller/processor 459 is used to receive a first signaling in the present application.

In one embodiment, at least one of the antenna 452, the transmitter 454, the multi-antenna transmitting processor 457, the transmitting processor 468 or the controller/processor 459 is used to transmit a first feedback message in the present application.

In one embodiment, at least one of the antenna 420, the receiver 418, the multi-antenna receiving processor 472, the receiving processor 470 or the controller/ processor 475 is used to receive a first feedback message in the present application.

In one embodiment, at least one of the antenna 420, the transmitter 418, the multi-antenna transmitting processor 471, the transmitting processor 416 or the controller/processor 475 is used to transmit a first message in the present application.

In one embodiment, at least one of the antenna 452, the receiver 454, the multi-antenna receiving processor 458, the receiving processor 456 or the controller/processor 459 is used to receive a first message in the present application.

In one embodiment, at least one of the antenna 452, the transmitter 454, the multi-antenna transmitting processor 457, the transmitting processor 468 or the controller/processor 459 is used to transmit a first random access preamble in the present application.

In one embodiment, at least one of the antenna 420, the receiver 418, the multi-antenna receiving processor 472, the receiving processor 470 or the controller/ processor 475 is used to receive a first random access preamble in the present application.

In one embodiment, at least one of the antenna 420, the transmitter 418, the multi-antenna transmitting processor 471, the transmitting processor 416 or the controller/processor 475 is used to transmit a first MAC PDU in the present application.

In one embodiment, at least one of the antenna 452, the receiver 454, the multi-antenna receiving processor 458, the receiving processor 456 or the controller/processor 459 is used to receive a first MAC PDU in the present application.

### Embodiment 5

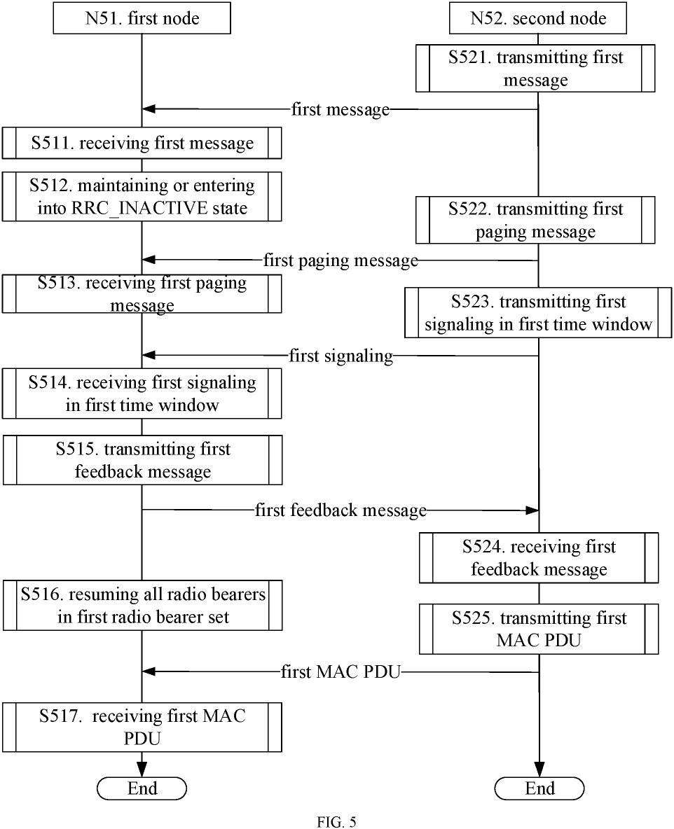

Embodiment 5 illustrates a flowchart of radio signal transmission when a first signaling is received and uplink time is aligned according to one embodiment of the present application, as shown in FIG. 5. In FIG. 5, a first node N51 and a second node N52 are in communications via a radio interface. It is particularly underlined that the order illustrated in the embodiment does not put constraints over sequences of signal transmissions and implementations.

The first node N51 receives a first message in step S511; maintains or enters into RRC_INACTIVE state in step S512; receives a first paging message in step S513; receives a first signaling in a first time window in step S514; transmits a first feedback message in step S515; resumes all radio bearers in a first radio bearer set in step S516; and receives a first MAC PDU in step S517.

The second node N52 transmits a first message in step S521; transmits a first paging message in step S522; transmits a first signaling in a first time window in step S523; receives a first feedback message in step S524; transmits the first MAC PDU in step S525.

In embodiment 5, a first paging message is received, and the first paging message indicates the first node; as a response to receiving the first paging message, a first signaling is monitored in a first time window, the first signaling is used to indicate resuming all radio bearers in a first radio bearer set; a first action is executed at least based on whether the first signaling is received; herein, the first action is one of transmitting a first feedback message or executing a first random access procedure; the behavior of executing a first action at least according to whether the first signaling is received comprises: when the first signaling is received and an uplink time is aligned, the first action is transmitting a first feedback message; when the first signaling is received and an uplink time is not aligned, or when the first signaling is not received, the first action is executing a first random access procedure; the first feedback message is used to confirm a reception of the first signaling; any radio bearer in the first radio bearer set is used for a data transmission in RRC_INACTIVE State, and the first radio bearer set comprises at least one radio bearer; accompanying transmitting the first feedback message, all radio bearers in the first radio bearer set are resumed; at least a running state of a first timer is used to determine whether an uplink time is aligned; receiving a first message before receiving the first paging message, the first message indicating the first radio bearer set; as a response to receiving the first message, maintaining or entering into the RRC_INACTIVE state; herein, the first message indicates that the first timer is not considered expired; the first signaling being used to activate a first scheduling; herein, the first message indicates the first scheduling, and the first scheduling is executed after being activated and before being de-activated; after all radio bearers in the first radio bearer set are resumed, receiving a first MAC PDU in the RRC_INACTIVE state, the first MAC PDU comprising at least one MAC subPDU, and a MAC subheader corresponding to each MAC SDU comprised in the at least one MAC subPDU indicates that the MAC SDU belongs to a radio bearer in the first radio bearer set.

In one embodiment, the second node is a base station of a serving cell of the first node.

In one embodiment, the second node is a base station of a primary cell of the first node.

In one embodiment, the second node is a base station of a secondary cell of the first node.

In one embodiment, the second node is a base station of a camping cell of the first node.

In one embodiment, a first message is received before receiving the first paging message, the first message indicates the first radio bearer set.

In one embodiment, after receiving the first message and before receiving the first paging message, the first node does not receive a user-specific network configuration message.

In one embodiment, the first message is used to indicate suspending an RRC connection.

In one embodiment, the first message comprises the first identity.

In one embodiment, the first message is an RRC signaling.

In one embodiment, the first message is RRCRelease, and the first message comprises suspendConfig.

In one embodiment, the first message comprises a first field, and the first field comprised in the first message comprises radio bearer identities of all radio bearers comprised in the first radio bearer set.

In one embodiment, the first field comprised in the first message is comprised in a suspendConfig field.

In one embodiment, the first field comprised in the first message is sdt-config.

In one embodiment, the first field comprised in the first message is dl-sdt-config.

In one embodiment, the first field comprised in the first message is mt (mobile-terminated)-sdt-config.

In one embodiment, the first message indicates that all radio bearers in the first radio bearer set can be used for data transmission in RRC_INACTIVE state.

In one embodiment, the first message indicates suspending all radio bearers in the first radio bearer set.

In one embodiment, when a radio bearer is suspended, the radio bearer is not used for data transmission.

In one embodiment, when a radio bearer is suspended, a radio bearer identifier of the radio bearer is not released.

In one embodiment, as a response to receiving the first message, maintain or enter into the RRC_INACTIVE state.

In one embodiment, the first node is in RRC_INACTIVE state when receiving the first message, it maintains the RRC_INACTIVE state.

In one embodiment, the first node is in RRC_CONNECTED state when receiving the first message, it enters into the RRC_INACTIVE state.

In one embodiment, the behavior of maintaining or entering into the RRC_INACTIVE state comprises: suspending all radio bearers in a second radio bearer set, the second radio bearer set comprises all radio bearers of the first node, and the first radio bearer set is a subset of the second radio bearer set.

In one embodiment, the behavior of maintaining or entering into the RRC_INACTIVE state comprises: indicating a PDCP suspension to lower layer of all suspended radio bearers.

In one embodiment, the behavior of maintaining or entering into the RRC_INACTIVE state comprises: re-establishing an RLC entity of SRB1.

In one embodiment, the behavior of maintaining or entering into the RRC_INACTIVE state comprises: when resetting a MAC and if there is a default MAC Cell Group configuration, releasing the default MAC Cell Group configuration.

In one embodiment, the behavior of maintaining or entering into the RRC_INACTIVE state comprises: indicating a suspension of RRC connection to upper layer.

In one embodiment, the behavior of maintaining or entering into the RRC_INACTIVE state comprises: executing a cell selection.

In one embodiment, when the first signaling is received and an uplink time is aligned, the first action is transmitting a first feedback message;

In one embodiment, transmitting the first feedback message is not used to switch an RRC state where the first node is located.

In one embodiment, accompanying transmitting the first feedback message, all radio bearers in the first radio bearer set are resumed.

In one embodiment, the phrase of accompanying transmitting the first feedback message, resuming all radio bearers in the first radio bearer set comprises: transmitting the first feedback message and resuming all radio bearers in the first wireless bearer set are inseparable (atomic).

In one embodiment, the phrase of accompanying transmitting the first feedback message, resuming all radio bearers in the first radio bearer set comprises: transmitting the first feedback message and resuming all radio bearers in the first wireless bearer set are associated with each other.

In one embodiment, the phrase of accompanying transmitting the first feedback message, resuming all radio bearers in the first radio bearer set comprises: transmitting the first feedback message is used to resume all radio bearers in the first radio bearer set.

In one embodiment, the phrase of accompanying transmitting the first feedback message, resuming all radio bearers in the first radio bearer set comprises: when the first feedback message is transmitted, resuming all radio bearers in the first radio bearer set.

In one embodiment, the phrase of accompanying transmitting the first feedback message, resuming all radio bearers in the first radio bearer set comprises: immediately after transmitting the first feedback message, resuming all radio bearers in the first radio bearer set.

In one embodiment, the phrase of accompanying transmitting the first feedback message, resuming all radio bearers in the first radio bearer set comprises: resuming all radio bearers in the first radio bearer set, transmitting the first feedback message.

In one embodiment, the phrase of accompanying transmitting the first feedback message, resuming all radio bearers in the first radio bearer set comprises: immediately after resuming all radio bearers in the first radio bearer set, transmitting the first feedback message.

In one embodiment, the phrase of resuming all radio bearers in a first radio bearer set comprises: for each radio bearer comprised in a first radio bearer set, resuming a configuration associated with a masterCellGroup and a Radio Link Control (RLC) bearer of Packet Data Convergence Protocol (pdcp)-Config from the UE Inactive AS context.

In one embodiment, the phrase of resuming all radio bearers in a first radio bearer set comprises: for each radio bearer comprised in a first radio bearer set, re-establishing a PDCP entity.

In one embodiment, the phrase of resuming all radio bearers in a first radio bearer set comprises: for each radio bearer comprised in a first radio carrier set, re-establishing a PDCP entity for a radio bearer without triggering a PDCP state report.

In one embodiment, the first processor, when uplink time is aligned, as a response to receiving the first signaling, resumes all radio bearers in the first radio bearer set.

In one embodiment, after all radio bearers in the first radio bearer set are resumed, a first MAC PDU is received in RRC_INACTIVE state, the first MAC PDU comprises at least one MAC subPDU, and a MAC subheader corresponding to each MAC SDU comprised in the at least one MAC subPDU indicates that the MAC SDU belongs to a radio bearer in the first radio bearer set.

In one subembodiment of the above embodiment, time-frequency resources occupied by the first MAC PDU belong to one of periodic time-frequency resources indicated by the first scheduling.

In one subembodiment of the above embodiment, the first receiver receives a first PDCCH signaling, and the first PDCCH signaling indicates time-frequency resources occupied by the first MAC PDU.

In one embodiment, a logical channel identity comprised in a MAC subheader is used to indicate a radio bearer to which a MAC SDU corresponding to the MAC sub-header belongs.

In one embodiment, an RLC bearer serves a radio bearer, and the RLC bearer is identified by a logical channel identity, and the logical channel identity is associated with the radio bearer.

In one embodiment, an RLC bearer corresponds to an RLC entity, and the RLC entity is configured by an RLC configuration.

In one embodiment, a sum of data volume of each MAC SDU comprised in the at least one MAC subPDU comprised in the first MAC PDU is less than a first threshold; herein, the at least one MAC subPDU comprised in the first MAC PDU is received after the first signaling.

In one embodiment, a sum of data volume of each MAC SDU comprised in the at least one MAC subPDU comprised in the first MAC PDU is equal to a first threshold; herein, the at least one MAC subPDU comprised in the first MAC PDU is received after the first signaling.

In one embodiment, data volume of a MAC SDU is a number of byte(s) comprised in the MAC SDU.

In one embodiment, the first threshold is configured by network.

In one embodiment, the first threshold is set by the network itself.

In one embodiment, the first threshold is used by the network to determine whether to execute DL-triggered triggered SDT.

In one subembodiment of the above embodiment, when data volume of downlink data belonging to all radio bearers in the first radio bearer set waiting to be transmitted is greater than the first threshold, it is determined that a DL-triggered SDT is not executed; when data volume of downlink data belonging to all radio bearers in the first radio bearer set waiting to be transmitted is not greater than the first threshold, it is determined that the DL-triggered small data transmission is executed.

In one embodiment, at least a running state of a first timer is used to determine whether an uplink time is aligned.

In one embodiment, when the first timer is in running state, uplink time is aligned; when the first timer is not in running state, uplink time is not aligned; herein, Reference Signal Received Power (RSRP) change threshold is not configured.

In one embodiment, when the first timer is in running state and a first RSRP change value is not greater than an RSRP change threshold, uplink time is aligned; when the first timer is in running state and the first RSRP change value is greater than the RSRP change threshold, or when the first timer is not in running state, uplink time is not aligned; herein, an RSRP change threshold is configured.

In one embodiment, the RSRP change threshold is used to define an increased or decreased RSRP threshold for uplink time alignment verification.

In one embodiment, the first RSRP change value is a value that increases or decreases compared to a current RSRP value calculated with reference to a downlink pathloss and a stored downlink pathloss reference RSRP value.

In one subembodiment of the above embodiment, according to the method defined in TS38.133 protocol of 3GPP standard, calculate a downlink pathloss with reference to a current RSRP value.

In one embodiment, the first timer is associated with a first timing advance group, the first timing advance group comprises at least one cell, the at least one cell is configured to use a same timing reference cell and a same timing advance value, and the first timing advance group comprises a cell on which the first node is camped.

In one embodiment, when a cell on which the first node is camped does not belong to the first timing advance group, the first timer is stopped.

In one embodiment, the first timer is maintained at MAC sublayer of the first node.

In one embodiment, the first timer is used to control a MAC entity of the first node to consider that the at least one cell comprised in the first timing advance group is a duration of uplink time alignment.

In one embodiment, the first timer is a timeAlignmentTimer.

In one embodiment, when a timing advance command is received, the first timer is started or re-started.

In one subembodiment of the above embodiment, the timing advance command is comprised in a random access response.

In one subembodiment of the above embodiment, the timing advance command is comprised in a timing advance command MAC CE.

In one embodiment, the first message indicates that the first timer is not considered expired.

In one embodiment, the first message comprises a second field, and the second field explicitly indicates that the first timer is not considered expired.

In one embodiment, when the first message comprises a timing advance command, the timing advance command implicitly indicates that the first timer is not considered expired.

In one subembodiment of the above embodiment, the timing advance command is applied to the first timing advance group.

In one subembodiment of the above embodiment, as a response to receiving the timing advance command, the first timer is started or re-started.

In one embodiment, the first message indicates at least one radio carrier for a DL-triggered SDT, and the at least one radio carrier for a DL-triggered SDT implicitly indicates that the first timer is not considered expired.

In one embodiment, the first message indicates at least one MRB received in RRC_INACTIVE state, and the at least one MRB received in RRC_INACTIVE state implicitly indicates that the first timer is not considered expired.

In one embodiment, the first signaling is used to activate a first scheduling; herein, the first message indicates the first scheduling, and the first scheduling is executed after being activated and before being de-activated.

In one embodiment, the first signaling is a PDCCH.

In one embodiment, the first signaling is Downlink Control Information (DCI).

In one embodiment, when the first signaling is used to activate the first scheduling, the first signaling is configured to schedule an RNTI scrambling.

In one subembodiment of the above embodiment, the configured scheduling-RNTI is Configured Scheduling-RNTI (CS-RNTI) or Group-CS-RNTI (G-CS-RNTI).

In one embodiment, contents of the first signaling are used to indicate an activation of the first scheduling.

In one embodiment, contents of the first signaling are used to indicate an activation of the first scheduling, and the contents of the first signaling satisfy the following three conditions: a format of the first signaling is one of DCI format 1_0 or DCI format 1_2; a value of a HARQ process number field comprised in the first signaling is full-zero; a value of a redundancy version (RV) field comprised in the first signaling is full-zero.

In one embodiment, contents of the first signaling are used to indicate an activation of the first scheduling, and the contents of the first signaling satisfy the following three conditions: a format of the first signaling is DCI format 1_1; a value of a HARQ process number field comprised in the first signaling is full-zero; a value of an RV field comprised in the first signaling for an enabled transport block is full-zero.

In one subembodiment of the above two embodiments, the first node is only provided with a downlink semi-persistent scheduling in a scheduled active Downlink/Uplink (DL/UL) BandWidth Part (BWP).

In one embodiment, contents of the first signaling are used to indicate an activation of the first scheduling, and the contents of the first signaling satisfy the following three conditions: a format of the first signaling is one of DCI format 1_0 or DCI format 1_2; a value of a redundancy version (RV) field comprised in the first signaling is full-zero.

In one embodiment, contents of the first signaling are used to indicate an activation of the first scheduling, and the contents of the first signaling satisfy the following three conditions: a format of the first signaling is DCI format 1_1; a value of an RV field comprised in the first signaling for an enabled transport block is full-zero.

In one subembodiment of the above two embodiments, the first node is provided with multiple downlink semi-persistent schedulings in an active DL/UL BWP of a scheduled cell.

In one subembodiment of the above two embodiments, a value of a HARQ process number field comprised in the first signaling is used to indicate the first scheduling.

In one embodiment, when conditions described in section 10.2 in TS38.213 protocol of3GPP standard are satisfied, the first signaling is used to activate the first scheduling.

In one embodiment, the first signaling comprises a first field, and the first field comprised in the first signaling is used to indicate uplink feedback information.

In one embodiment, the first field comprised in the first signaling is an Uplink feedback information (UFI) flag field.

In one subembodiment of the above embodiment, the UFI flag field is set to 1.

In one embodiment, the first message indicates the first scheduling.

In one embodiment, the first message comprises a third field, and the third field comprised in the first message is used to indicate the first scheduling.

In one subembodiment of the above embodiment, the third field is sps-config.

In one embodiment, the third field comprised in the first message comprises a period of time-domain resources comprised in the periodic time-frequency resources indicated by the first scheduling.

In one embodiment, the first signaling comprises frequency-domain resources indicated by the first scheduling and a start position of the time-domain resources comprised in the periodic time-frequency resources indicated by the first scheduling.

In one embodiment, the first signaling comprises the Modulation and Coding Scheme (MCS) indicated by the first scheduling.

In one embodiment, the third field comprised in the first message comprises a HARQ process number indicated by the first scheduling.

In one embodiment, the third field comprised in the first message comprises a HARQ process number offset indicated by the first scheduling.

In one embodiment, the first scheduling is executed after being activated and before being de-activated.

In one embodiment, the phrase of the first scheduling being executed after being activated and before being de-activated is: the first scheduling is used for Semi-Persistent Scheduling (SPS).

In one embodiment, the phrase of the first scheduling being executed after being activated and before being de-activated is: the first scheduling is configuring a downlink assignment.

In one embodiment, the first scheduling indicates periodic time-frequency resources.

In one embodiment, the periodic time-frequency resources indicated by the first scheduling are used for data transmission in the RRC_INACTIVE state.

In one embodiment, after the first scheduling is activated, the first node monitors a radio signal on the periodic time-frequency resources indicated by the first scheduling.

In one subembodiment of the above embodiment, the radio signal is scrambled by the configured scheduling RNTI.

In one subembodiment of the above embodiment, the radio signal is scrambled by a C-RNTI or a G-RNTI.

In one embodiment, the first signaling is used to activate the first scheduling; herein, the first scheduling is stored before receiving the first message, and the first message is not used to release the first scheduling.

In one subembodiment of the above embodiment, the first message comprises a fourth field, and the fourth field comprised in the first message is used to indicate not releasing the first scheduling.

In one embodiment, a time-frequency resource comprises at least one frequency-domain resource and at least one time-domain resource.

In one embodiment, a frequency-domain resource is a subcarrier.

In one embodiment, a frequency-domain resource is a Resource Block (RB), and the RB comprises 12 subcarriers.

In one embodiment, a time-domain resource is a symbol.

In one embodiment, a time-domain resource is a multicarrier symbol.

In one embodiment, a time-domain resource is an Orthogonal Frequency Division Multiplexing (OFDM) symbol.

In one embodiment, a time-domain resource is a slot.

In one embodiment, a time-domain resource is a subframe.

### Embodiment 6

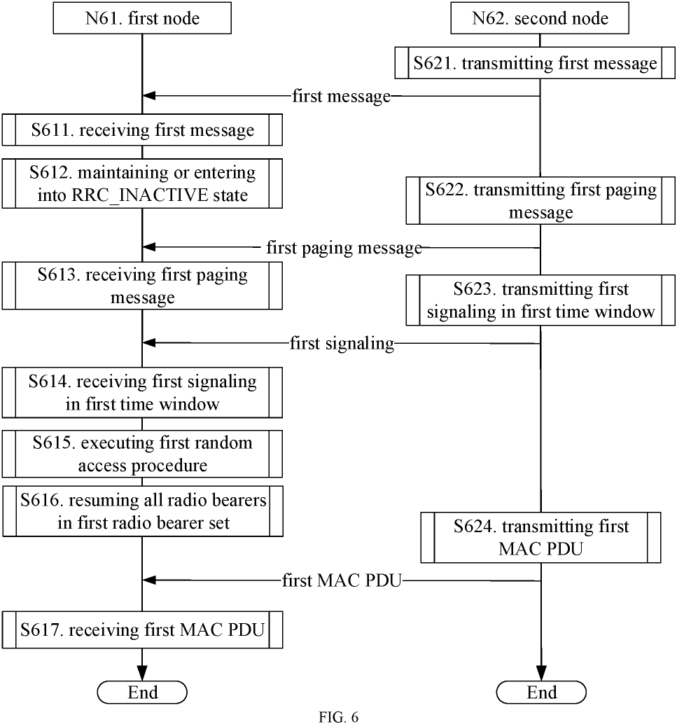

Embodiment 6 illustrates a flowchart of radio signal transmission when a first signaling is received and uplink time is not aligned according to one embodiment of the present application, as shown in FIG. 6. In FIG. 6, a first node N61 and a second node N62 are in communications via a radio interface. It is particularly underlined that the order illustrated in the embodiment does not put constraints over sequences of signal transmissions and implementations.

The first node N61 receives a first message in step S611; maintains or enters into RRC_INACTIVE state in step S612; receives a first paging message in step S613; receives a first signaling in a first time window in step S614; executes a first random access procedure in step S615; resumes all radio bearers in a first radio bearer set in step S616; receives a first MAC PDU in step S617.

The second node N62 transmits a first message in step S621; transmits a first paging message in step S622; transmits a first signaling in a first time window in step S623; transmits the first MAC PDU in step S624.

In embodiment 6, distinguishing from embodiment 5, when the first signaling is received and uplink time is not aligned, accompanying executing a first random access procedure, all radio bearers in the first radio bearer set are resumed; herein, the first random access procedure is an SDT-triggered random access procedure.

It should be noted that it is not detailed in FIG. 6, but the execution of the first random access procedure by the first node comprises a radio signal interaction between the first node and the second node.

Specifically, when the first random access procedure is a contention-based 4-step random access procedure, comprising step 1, the first node N61 transmits a first random access preamble to the second node N62; step 2, the first node N61 receives a random access response (RAR) from the second node N62; step 3, the first node N61 transmits a scheduled Msg3 to the second node N62; step 4, the first node N61 receives a contention resolution from the second node N62.

Specifically, when the first random access procedure is contention-based 2-step random access procedure, comprising step 1, the first node N61 transmits MsgA to the second node N62, and the MsgA comprises a first random access preamble and a PUSCH payload; step 2, the first node N61 receives a contention resolution from the second node N62.

Specifically, when the first random access procedure is a contention-free 4-step random access procedure, comprising step 1, the first node N61 transmits a first random access preamble to the second node N62; step 2, the first node N61 receives a random access response (RAR) from the second node N62.

Specifically, when the first random access procedure is a non-contention-based 2-step random access procedure, comprising step 1, the first node N61 transmits MsgA to the second node N62, and the MsgA comprises a first random access preamble and a PUSCH payload; step 2, the first node N61 receives a random access response (RAR) from the second node N62.

In one embodiment, when uplink time is not aligned, the first signaling is used to trigger an RA-SDT.

In one embodiment, when the first signaling is received and an uplink time is not aligned, the first action is executing a first random access procedure, and the first random access procedure is an SDT-triggered random access procedure.

In one subembodiment of the above embodiment, the behavior of executing a first random access procedure comprises transmitting a first random access preamble, the first random access preamble is reserved for an SDT-triggered random access procedure, or time-frequency resources occupied by the first random access preamble are reserved for an SDT-triggered random access procedure.

In one subembodiment of the above embodiment, executing the first random access procedure is not used to switch an RRC state where the first node is located.

In one embodiment, the first random access preamble is a characteristic sequence.

In one embodiment, a characteristic sequence is a pseudo random sequence.

In one embodiment, a characteristic sequence is a Gold sequence.

In one embodiment, a characteristic sequence is an M sequence.

In one embodiment, a characteristic sequence is a Zadoff-chu (ZC) sequence.

In one embodiment, when the first signaling is received and an uplink time is not aligned, the behavior of executing the first random access procedure comprises transmitting an RRC resume request message.

In one subembodiment of the above embodiment, the RRC resume request message is one of RRCResumeRequest or RRCResumeRequest1.

In one subembodiment of the above embodiment, the RRC resume request message is used to request resuming an RRC connection.

In one subembodiment of the above embodiment, the RRC resume request message is comprised in Msg3 in the first random access procedure; herein, the first random access procedure is 4-step random access procedure, and time-frequency resources occupied by the Msg3 are indicated by a Random Access Response (RAR) of the first random access procedure.

In one subembodiment of the above embodiment, the RRC resume request message is comprised in a PUSCH payload of MsgA in the first random access procedure; herein, the first random access procedure is 2-step random access procedure, and time-frequency resources occupied by the MsgA are associated with a Physical Random Access CHannel (PRACH) of the first random access procedure.

In one subembodiment of the above embodiment, a logical channel occupied by the RRC resume request message is a Common Control CHannel (CCCH).

In one embodiment, when the first signaling is received and uplink time is not aligned, accompanying executing the first random access procedure, all radio bearers in the first radio bearer set are resumed.

In one embodiment, when the first signaling is received and an uplink time is not aligned, accompanying executing the first random access procedure, SRB1 is resumed.

In one embodiment, the phrase of accompanying the first random access procedure, resuming all radio bearers in the first radio bearer set also comprises: when initiating the first random access procedure, resuming all radio bearers in the first radio bearer set.

In one embodiment, the phrase of accompanying executing the first random access procedure, resuming all radio bearers in the first radio bearer set also comprises: when initiating an SDT procedure, resuming all radio bearers in the first radio bearer set.

In one embodiment, the phrase of accompanying executing the first random access procedure, resuming all radio bearers in the first radio bearer set also comprises: accompanying transmitting the first random access preamble, resuming all radio bearers in the first radio bearer set; herein, the behavior of executing the first random access procedure comprises transmitting the first random access preamble.

In one embodiment, the phrase of accompanying executing the first random access procedure, resuming all radio bearers in the first radio bearer set comprises: accompanying transmitting the RRC resume request message, resuming all radio bearers in the first radio bearer set; herein, the behavior of executing the first random access procedure comprises transmitting an RRC resume request message.

In one embodiment, the phrase of accompanying executing the first random access procedure, and the understanding of resuming all radio bearers in the first radio bearer set can refer to the above description, which will not be repeated here.

In one embodiment, the phrase of accompanying transmitting the RRC resume request message, and the understanding of resuming all radio bearers in the first radio bearer set can refer to the above description, which will not be repeated here.

In one embodiment, the phrase of accompanying transmitting the first random access preamble, and the understanding of resuming all radio bearers in the first radio bearer set can refer to the above description, which will not be repeated here.

### Embodiment 7

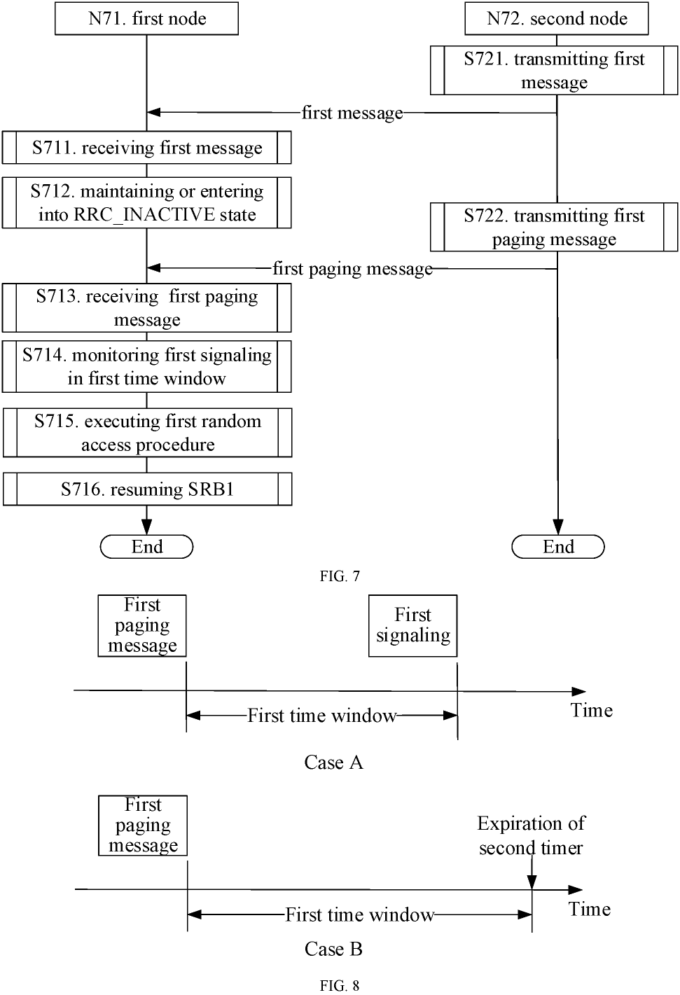

Embodiment 7 illustrates a flowchart of radio signal transmission of not receiving a first signaling according to one embodiment of the present application, as shown in FIG. 7. In FIG. 7, a first node N71 and a second node N72 are in communications via a radio interface. It is particularly underlined that the order illustrated in the embodiment does not put constraints over sequences of signal transmissions and implementations.

The first node N71 receives a first message in step S711; maintains or enters into RRC_INACTIVE state in step S712; receives a first paging message in step S713; monitors a first signaling in a first time window in step S714; executes a first random access procedure in step S715; resumes SRB1 in step S716.

The second node N72 transmits a first message in step S721; transmits a first paging message in step S722.

In embodiment 7, distinguishing from embodiment 5 and embodiment 6, when the first signaling is not received, and before the first random access procedure is successfully completed, all radio bearers in the first radio bearer set are not resumed; herein, the first random access procedure is a non-SDT-triggered random access procedure.

It should be noted that though not illustrated in FIG. 7 but as in embodiment 6, the execution of the first random access procedure by the first node comprises a radio signal interaction between the first node and the second node.

In one embodiment, when the first signaling is not received, the first action is to execute a first random access procedure, and the first random access procedure is a non-SDT-triggered random access procedure.

In one subembodiment of the above embodiment, the behavior of executing a first random access procedure comprises transmitting a first random access preamble, the first random access preamble is reserved for a non-SDT-triggered random access procedure, or time-frequency resources occupied by the first random access preamble are reserved for a non-SDT-triggered random access procedure.

In one embodiment, when the first signaling is not received, and before the first random access procedure is successfully completed, all radio bearers in the first radio bearer set are not resumed.

In one embodiment, when the first signaling is not received, and before the first random access procedure is successfully completed, suspended states of all radio bearers in the first radio bearer set are maintained.

In one embodiment, the behavior of executing a first random access procedure comprises receiving a second message, and the second message is used to indicate a successful completion of the first random access procedure.

In one embodiment, the second message is contention resolution.

In one embodiment, the second message is a random access response.

In one embodiment, the second message is MsgB in 2-step random access procedure.

In one embodiment, the second message is a MAC CE.

In one embodiment, the second message is a UE Contention Resolution Identity MAC CE.

In one embodiment, the second message is successRAR.

In one embodiment, when the first signaling is not received, accompanying executing the first random access procedure, only SRB1 is resumed.

In one embodiment, the phrase of accompanying executing the first random access procedure, resuming SRB1 comprises: accompanying transmitting an RRC resume request message, resuming SRB1; herein, the behavior of executing the first random access procedure comprises transmitting the RRC resume request message.

In one embodiment, the understanding of the phrase of accompanying transmitting the RRC resume request message, resuming SRB1 can refer to the above description, which will not be repeated here.

In one embodiment, when the first signaling is not received, and after the first random access procedure is successfully completed, whether all radio bearers in the first radio bearer set are resumed is determined according to a signaling transmitted by the network.

In one embodiment, when the first signaling is not received, and after the first random access procedure is successfully completed, maintaining or switching RRC state where the first node is located is determined according to a signaling transmitted by the network.

### Embodiment 8

Embodiment 8 illustrates a schematic diagram of a first time window according to one embodiment of the present application, as shown in FIG. 8.

In one embodiment, a length of the first time window is variable.

In one embodiment, the length of the first time window is a duration when a second timer is in running state.

In one embodiment, a start time of the first time window is a time when the second timer starts.

In one embodiment, as a response to receiving the first paging message, the second timer is started.

In one embodiment, an end time of the first time window is a time when the second timer stops or expires.

In one embodiment, when the first signaling is received, the second timer is stopped.

In one embodiment, the length of the first time window is determined by whether the first signaling is received and a time when the first signaling is received.

In one subembodiment of the above embodiment, when the first signaling is received, an end time of the first time window is an end time of time-domain resources occupied by the first signaling.

In one subembodiment of the above embodiment, when the first signaling is not received, an end time of the first time window is a time when the second timer is expired.

In one embodiment, an expiration value of the second timer is pre-configured.

In one embodiment, the expiration value of the second timer is configurable.

In one embodiment, the expiration value of the second timer is standard -specific.

In one embodiment, when the second timer is in running state, the first signaling is monitored.

In one embodiment, after receiving the first signaling, whether to continue monitoring is determined by the UE itself; herein, the second timer is maintained until it expires.

In case A of embodiment 8, an end time of time-domain resources occupied by the first signaling is an end time of the first time window.

In case B of embodiment 8, an expiration time of the second timer is an end time of the first time window.

In one embodiment, when the second timer is in a running state, the second timer is updated in each first time interval.

In one embodiment, a value of the second timer is set to 0 when the second timer is started, and the phrase of updating a second timer comprises: adding a value of the second timer by 1; when a value of the second timer is the expiration value of the second timer, the second timer expires.

In one embodiment, a value of the second timer is set to the expiration value of the second timer when the second timer is started, and the phrase of updating the second timer comprises: decreasing a value of the second timer by 1; when a value of the second timer is 0, the second timer is expired.

In one embodiment, the first time interval is 1 millisecond (ms).

In one embodiment, the first time interval is a subframe.

In one embodiment, the first time interval is a slot.

In one embodiment, the second timer is maintained at MAC sublayer.

In one embodiment, the second timer is maintained at PHY layer.

In one embodiment, the second timer is maintained at PHY sublayer.

In one embodiment, a name of the second timer comprises window.

In one embodiment, a name of the second timer comprises an SDT.

### Embodiment 9

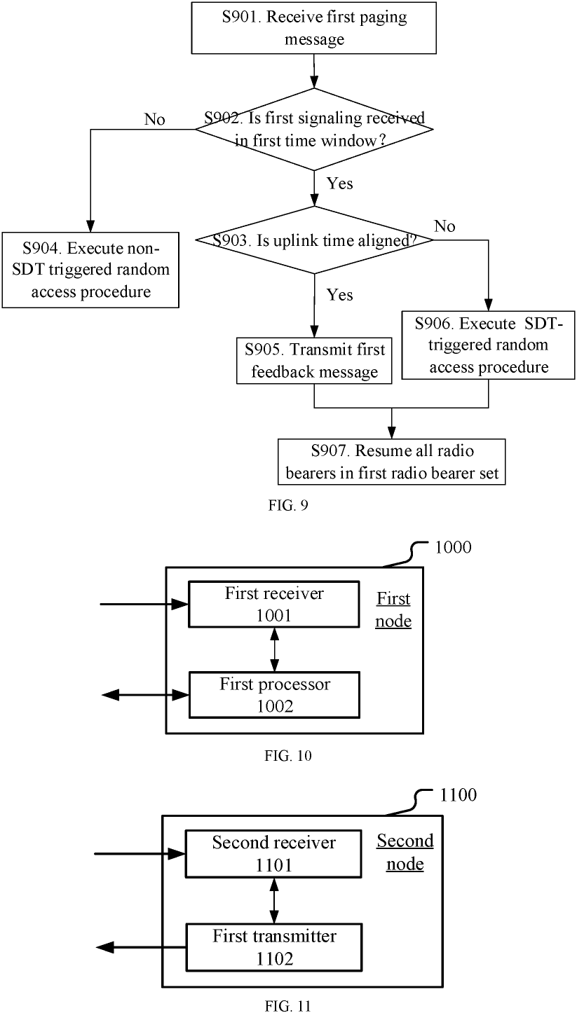

Embodiment 9 illustrates a flowchart of specific signal processing in a first node according to one embodiment of the present application, as shown in FIG. 9. Steps illustrated by FIG. 9 are implemented in a first node.

In embodiment 9, a first paging message is received in step S901; in step S902, whether a first signaling is received in the first time window is judged; if yes, proceed to step S903, if not, proceed to step S904; in step S904, execute a non-SDT triggered random access procedure; in step S903, judge whether uplink time is aligned, if yes, execute step S905, if no, execute step S906; transmit a first feedback message in step S905; in step S906, execute an SDT-triggered random access procedure; resume all radio bearers in a first radio bearer set in step S907.

### Embodiment 10

Embodiment 10 illustrates a structure block diagram of a processor in a first node according to one embodiment of the present application, as shown in FIG. 10. In FIG. 10, a processor 1000 in a first node comprises a first receiver 1001 and a first processor 1002; the first node 1000 is a UE.

In embodiment 10, the first receiver 1001 receives a first paging message, and the first paging message indicates the first node; as a response to receiving the first paging message, monitoring a first signaling in a first time window, the first signaling being used to indicate resuming all radio bearers in a first radio bearer set; the first processor 1002 executes a first action at least according to whether the first signaling is received; herein, the first action is one of transmitting a first feedback message or executing a first random access procedure; the behavior of executing a first action at least according to whether the first signaling is received comprises: when the first signaling is received and an uplink time is aligned, the first action is transmitting a first feedback message; when the first signaling is received and an uplink time is not aligned, or when the first signaling is not received, the first action is executing a first random access procedure; the first feedback message is used to confirm a reception of the first signaling; any radio bearer in the first radio bearer set is used for a data transmission in RRC_INACTIVE State, and the first radio bearer set comprises at least one radio bearer.

In one embodiment, the first processor 1002, accompanying transmitting the first feedback message, resumes all radio bearers in the first radio bearer set.

In one embodiment, the first processor 1002, when the first signaling is received and uplink time is not aligned, accompanying executing a first random access procedure, resumes all radio bearers in the first radio bearer set; herein, the first random access procedure is an SDT-triggered random access procedure.

In one embodiment, when the first signaling is not received, and before the first random access procedure is successfully completed, all radio bearers in the first radio bearer set are not resumed; herein, the first random access procedure is a non-SDT-triggered random access procedure.

In one embodiment, at least a running state of a first timer is used to determine whether an uplink time is aligned.

In one embodiment, at least a running state of a first timer is used to determine whether an uplink time is aligned; the first receiver 1001, receives a first message before receiving the first paging message, and the first message indicates the first radio bearer set; the first processor 1002, as a response to receiving the first message, maintains or enters into the RRC_INACTIVE state; herein, the first message indicates that the first timer is not considered expired.

In one embodiment, the first receiver 1001, receives a first message before receiving the first paging message, and the first message indicates the first radio bearer set; the first processor 1002, as a response to receiving the first message, maintains or enters into the RRC_INACTIVE state; herein, the first message indicates that the first timer is not considered expired; the first signaling being used to activate a first scheduling; herein, the first message indicates the first scheduling, and the first scheduling is executed after being activated and before being de-activated.

In one embodiment, the first receiver 1001, after all radio bearers in the first radio bearer set are resumed, receives a first MAC PDU in the RRC_INACTIVE state, the first MAC PDU comprises at least one MAC subPDU, and a MAC subheader corresponding to each MAC SDU comprised in the at least one MAC subPDU indicates that the MAC SDU belongs to a radio bearer in the first radio bearer set.

In one embodiment, the first receiver 1001 comprises the receiver 454 (comprising the antenna 452), the receiving processor 456, the multi-antenna receiving processor 458 and the controller/processor 459 in FIG. 4 of the present application.

In one embodiment, the first receiver 1001 comprises at least one of the receiver 454 (comprising the antenna 452), the receiving processor 456, the multi-antenna receiving processor 458 or the controller/ processor 459 in FIG. 4 of the present application.

In one embodiment, the first processor 1002 comprises the receiver 454 (comprising the antenna 452), the receiving processor 456, the multi-antenna receiving processor 458 and the controller/processor 459 in FIG. 4 of the present application.

In one embodiment, the first processor 1002 comprises at least one of the receiver 454 (comprising the antenna 452), the receiving processor 456, the multi-antenna receiving processor 458 or the controller/ processor 459 in FIG. 4 of the present application.

In one embodiment, the first processor 1002 comprises the transmitter 454 (comprising the antenna 452), the transmitting processor 468, the multi-antenna transmitting processor 457 and the controller/processor 459 in FIG. 4 of the present application.

In one embodiment, the first processor 1002 comprises at least one of the transmitter 454 (comprising the antenna 452), the transmitting processor 468, the multi-antenna transmitting processor 457 or the controller/processor 459 in FIG. 4 of the present application.

In one embodiment, the first processor 1002 comprises the controller/processor 459 in FIG. 4 of the present application.

### Embodiment 11

Embodiment 11 illustrates a structure block diagram of a processor in a second node according to one embodiment of the present application, as shown in FIG. 11. In FIG. 11, a processor 1100 in a second node comprises a second receiver 1101 and a first transmitter 1102; the second node 1100 is a base station.

In embodiment 11, the first transmitter 1102 transmits a first paging message, and the first paging message indicates the first node; immediately after transmitting the first paging message, transmits a first signaling in a first time window, the first signaling is used to indicate resuming all radio bearers in a first radio bearer set; herein, a first action is executed at least according to whether the first signaling is received; the first action is one of transmitting a first feedback message or executing a first random access procedure; a first action being executed at least according to whether the first signaling is received comprises: when the first signaling is received and an uplink time is aligned, a first feedback message is transmitted; when the first signal is received and an uplink time is not aligned, or when the first signaling is not received, a first random access procedure is executed; the first feedback message is used to confirm a reception of the first signaling; any radio bearer in the first radio bearer set is used for a data transmission in RRC_INACTIVE State, and the first radio bearer set comprises at least one radio bearer.

In one embodiment, the second receiver 1101 receives the first feedback message; herein, the first signaling is received and an uplink time is aligned.

In one embodiment, accompanying the first feedback message being transmitted, all radio bearers in the first radio bearer set are resumed.

In one embodiment, the second receiver 1101 receives a first random access preamble; herein, the first signaling is received and an uplink time is not aligned; the behavior of receiving the first random access preamble belongs to the first random access procedure, and the first random access procedure is an SDT-triggered random access procedure.

In one embodiment, when the first signaling is received and an uplink time is not aligned, accompanying the first random access procedure is executed, all radio bearers in the first radio bearer set are resumed; herein, the first random access procedure is an SDT-triggered random access procedure.

In one embodiment, the second receiver 1101 receives a first random access preamble; herein, the first signaling is not received; the behavior of receiving the first random access preamble belongs to the first random access procedure, and the first random access procedure is a non-SDT-triggered random access procedure.

In one embodiment, when the first signaling is not received, and before the first random access procedure is successfully completed, all radio bearers in the first radio bearer set are not resumed; herein, the first random access procedure is a non-SDT-triggered random access procedure.

In one embodiment, at least a running state of a first timer is used to determine whether an uplink time is aligned.

In one embodiment, at least a running state of a first timer is used to determine whether an uplink time is aligned; the first transmitter 1102, transmits a first message before transmitting the first paging message, and the first message indicates the first radio bearer set; herein, the first message is used to indicate maintaining or entering into the RRC_INACTIVE state, and the first message indicates that the first timer is not considered expired.

In one embodiment, the first transmitter 1102, transmits a first message before transmitting the first paging message, and the first message indicates the first radio bearer set; herein, the first message is used to indicate maintaining or entering into the RRC_INACTIVE state, and the first message indicates that the first timer is not considered expired; the first signaling being used to activate a first scheduling; herein, the first message indicates the first scheduling, and the first scheduling is executed after being activated and before being de-activated.

In one embodiment, the first transmitter 1102, after all radio bearers in the first radio bearer set are resumed, transmits a first MAC PDU, the first MAC PDU comprises at least one MAC subPDU, and a MAC subheader corresponding to each MAC SDU comprised in the at least one MAC subPDU indicates that the MAC SDU belongs to a radio bearer in the first radio bearer set.

In one embodiment, the second receiver 1101 comprises the receiver 418 (comprising the antenna 420), the receiving processor 470, the multi-antenna receiving processor 472 and the controller/processor 475 in FIG. 4 in the present application.

In one embodiment, the second receiver 1101 comprises at least one of the receiver 418 (comprising the antenna 420), the receiving processor 470, the multi-antenna receiving processor 472 or the controller/processor 475 in FIG. 4 in the present application.

In one embodiment, the second receiver 1101 comprises the controller/processor 475 in FIG. 4 of the present application.

In one embodiment, the first transmitter 1101 comprises the transmitter 418 (including the antenna 420), the transmitting processor 416, the multi-antenna transmitting processor 471 and controller/processor 475 in FIG. 4 of the present application.

In one embodiment, the first transmitter 1101 comprises at least one of the transmitter 418 (including the antenna 420), the transmitting processor 416, the multi-antenna transmitting processor 471 or the controller/ processor 475 in FIG. 4 of the present application.

In one embodiment, the first transmitter 1101 comprises the controller/processor 475 in FIG. 4 of the present application.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. A first-type communication node or a UE or a terminal in the present application includes but not limited to mobile phones, tablet computers, laptops, network cards, low-power devices, enhanced Machine Type Communication (eMTC) devices, NB-IOT devices, vehicle-mounted communication equipment, aircrafts, airplanes, unmanned aerial vehicles (UAV), telecontrolled aircrafts and other wireless communication devices. The second-type communication node or the base station or the network side device in the present application includes but is not limited to the macro-cellular base stations, micro-cellular base stations, home base stations, relay base stations, eNBs, gNBs, Transmission and Reception Points (TRP), relay satellites, satellite base stations, air base stations and other wireless communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless com 1munications, comprising:
a first receiver, receiving a first paging message, the first paging message indicating the first node; as a response to receiving the first paging message, monitoring a first signaling in a first time window, the first signaling being used to indicate resuming all radio bearers in a first radio bearer set; and
a first processor, executing a first action at least according to whether the first signaling is received;
wherein the first action is one of transmitting a first feedback message or executing a first random access procedure; the behavior of executing a first action at least according to whether the first signaling is received comprises: when the first signaling is received and an uplink time is aligned, the first action is transmitting a first feedback message; when the first signaling is received and an uplink time is not aligned, or when the first signaling is not received, the first action is executing a first random access procedure; the first feedback message is used to confirm a reception of the first signaling; any radio bearer in the first radio bearer set is used for a data transmission in RRC_INACTIVE State, and the first radio bearer set comprises at least one radio bearer.

2. The first node according to claim 1, comprising:
the first processor, accompanying transmitting the first feedback message, resuming all radio bearers in the first radio bearer set.

3. The first node according to claim 1, comprising:
the first processor, when the first signaling is received and uplink time is not aligned, accompanying executing the first random access procedure, resuming all radio bearers in the first radio bearer set;
wherein the first random access procedure is an SDT-triggered random access procedure.

4. The first node according to claim 1, wherein when the first signaling is not received, and before the first random access procedure is successfully completed, all radio bearers in the first radio bearer set are not resumed;
wherein the first random access procedure is a non-SDT-triggered random access procedure.

5. The first node according to claim 1, wherein at least a running state of a first timer is used to determine whether an uplink time is aligned.

6. The first node according to claim 5, comprising:
the first receiver, receiving a first message before receiving the first paging message, the first message indicating the first radio bearer set; and
the first processor, as a response to receiving the first message, maintaining or entering into the RRC_INACTIVE state;
wherein the first message indicates that the first timer is not considered expired.

7. The first node according to claim 6, wherein the first signaling is used to activate a first scheduling;
wherein the first message indicates the first scheduling, and the first scheduling is executed after being activated and before being de-activated.

8. The first node according to claim 1, comprising:
the first receiver, after all radio bearers in the first radio bearer set being resumed, receiving a first MAC PDU in the RRC_INACTIVE state, the first MAC PDU comprising at least one MAC subPDU, and a MAC subheader corresponding to each MAC SDU comprised in the at least one MAC subPDU indicating that the MAC SDU belongs to a radio bearer in the first radio bearer set.

9. A second node for wireless communications, comprising:
a first transmitter, transmitting a first paging message, the first paging message indicating the first node; immediately after transmitting the first paging message, transmitting a first signaling in a first time window, the first signaling being used to indicate resuming all radio bearers in a first radio bearer set;
wherein a first action is executed at least according to whether the first signaling is received; the first action is one of transmitting a first feedback message or executing a first random access procedure; a first action being executed at least according to whether the first signaling is received comprises: when the first signaling is received and an uplink time is aligned, a first feedback message is transmitted; when the first signal is received and an uplink time is not aligned, or when the first signaling is not received, a first random access procedure is executed; the first feedback message is used to confirm a reception of the first signaling; any radio bearer in the first radio bearer set is used for a data transmission in RRC_INACTIVE State, and the first radio bearer set comprises at least one radio bearer.

10. The second node according to claim 9, comprising:
a second receiver, receiving the first feedback message;
wherein the first signaling is received and an uplink time is aligned.

11. The second node according to claim 9, comprising:
a second receiver, receiving a first random access preamble;
wherein the first signaling is received and an uplink time is not aligned; the behavior of receiving the first random access preamble belongs to the first random access procedure, and the first random access procedure is an SDT-triggered random access procedure.

12. The second node according to claim 9, comprising:
a second receiver, receiving a first random access preamble;
wherein the first signaling is not received; the behavior of receiving the first random access preamble belongs to the first random access procedure, and the first random access procedure is a non-SDT-triggered random access procedure.

13. The second node according to claim 9, wherein at least a running state of a first timer is used to determine whether an uplink time is aligned.

14. The second node according to claim 13, comprising:
the first transmitter, transmitting a first message before transmitting the first paging message, the first message indicating the first radio bearer set;
wherein the first message is used to indicate maintaining or entering into the RRC_INACTIVE state, and the first message indicates that the first timer is not considered expired.

15. The second node according to claim 9, comprising:
the first transmitter, after all radio bearers in the first radio bearer set being resumed, transmitting a first MAC PDU, the first MAC PDU comprising at least one MAC subPDU, and a MAC subheader corresponding to each MAC SDU comprised in the at least one MAC subPDU indicating that the MAC SDU belongs to a radio bearer in the first radio bearer set.

16. A method in a first node for wireless communications, comprising:
receiving a first paging message, the first paging message indicating the first node;
as a response to receiving the first paging message, monitoring a first signaling in a first time window, the first signaling being used to indicate resuming all radio bearers in a first radio bearer set; and
executing a first action at least according to whether the first signaling is received;
wherein the first action is one of transmitting a first feedback message or executing a first random access procedure; the behavior of executing a first action at least according to whether the first signaling is received comprises: when the first signaling is received and an uplink time is aligned, the first action is transmitting a first feedback message; when the first signaling is received and an uplink time is not aligned, or when the first signaling is not received, the first action is executing a first random access procedure; the first feedback message is used to confirm a reception of the first signaling; any radio bearer in the first radio bearer set is used for a data transmission in RRC_INACTIVE State, and the first radio bearer set comprises at least one radio bearer.

17. The method in a first node according to claim 16, comprising:
accompanying transmitting the first feedback message, resuming all radio bearers in the first radio bearer set.

18. The method in a first node according to claim 16, comprising:
when the first signaling is received and uplink time is not aligned, accompanying executing the first random access procedure, resuming all radio bearers in the first radio bearer set;
wherein the first random access procedure is an SDT-triggered random access procedure.

19. The method in a first node according to claim 16, wherein when the first signaling is not received, and before the first random access procedure is successfully completed, all radio bearers in the first radio bearer set not being resumed;
wherein the first random access procedure is a non-SDT-triggered random access procedure.

20. The method in a first node according to claim 16, comprising:
receiving a first message before receiving the first paging message, the first message indicating the first radio bearer set; and
as a response to receiving the first message, maintaining or entering into the RRC_INACTIVE state;
wherein at least a running state of a first timer is used to determine whether an uplink time is aligned; the first message indicates that the first timer is not considered expired.
